(19) United States
(12) Patent Application Publication
(10) Pub. No.: US 2018/0315124 A1
(43) Pub. Date: Nov. 1, 2018

(54) ORDER ALLOCATION

(71) Applicant: Nasdaq Technology AB, Stockholm (SE)

(72) Inventor: Jan TILFORS, Stockholm (SE)

(21) Appl. No.: 16/030,115

(22) Filed: Jul. 9, 2018

Related U.S. Application Data
(63) Continuation of application No. 13/600,805, filed on Aug. 31, 2012, now abandoned.

(51) Int. Cl. G06Q 40/04

(52) U.S. Cl. CPC G06Q 40/04

(57) ABSTRACT

In an automated exchange, an incoming sell order is allocated to standing buy orders based on the aggregated time the trading participant having standing buy orders have spent on a best-bid-offer (BBO) value. Hereby, it is made possible to improve trading of some financial instruments when it is desired to favor, or reward, order allocation to trading participants that bring liquidity to the market of the financial instrument in question.

### PRIORITY APPLICATION

This application is a continuation of U.S. application Ser. No. 13/600,805 filed Aug. 31, 2012, the contents of which are hereby incorporated by reference.

### TECHNICAL FIELD

Present invention generally relates to order allocation. More particularly, embodiments of the present invention relate to determining how a quantity of an order in a market is allocated to other orders in the market. According to some aspects of this disclosure, there are provided methods and automated exchanges for allocating a quantity of an incoming sell order to standing, or unmatched, buy orders.

### BACKGROUND

When a seller and a buyer agree to a particular price for a financial instrument they complete a trade. I.e. they complete a verbal, or electronic, transaction involving one party buying a financial instrument from another party. The trades are typically initiated and completed by trading participants such as individuals, firms, dealers (who may be either individuals or firms), traders and brokers. Trading of financial instruments is generally performed on an exchange, i.e. a trading venue, and the trading is typically done through brokers, or traders, who buy or sell the financial instruments on behalf of the order owners. Thus, there are a variety of exchange participants which are coupled to the automated exchange through the members of the exchange. As used in this disclosure, the term “financial instrument” should be understood in a broad sense and encompasses any tradable item i.e. securities, derivative or commodity, such as stocks, bonds, cash, swaps, futures, foreign exchange, options, gas electricity and so forth, or group of items that is traded through matching of counterparty orders (bid, offer).

An automated exchange typically receives signals comprising order data messages, in the form of data messages, from external devices used by traders, or brokers. The traders, or brokers, submit orders and/or quotes (or alterations/cancellations thereof) to the automated exchange for purposes of trading. In this context, an order is a request to sell or buy a financial instrument from any trading participant of the automated exchange and a “quote” may be an “offer” price, a “bid” price, or a combination of both an “offer” and “bid” price of a financial instrument, and is determined from quotations made by trading participants (or dealers).

The orders/quotes may relate to buying and/or selling of any type of financial instrument. In particular, the signal comprising an order data message and which is received by the automated exchange can be an order data message that represents the placing of a new bid or sell order, or a new quote. The order data message can also represent the change of an existing bid or sell order, or a quote. In addition, the order data message can represent a cancellation/change of an existing bid or sell order, or a quote.

FIG. 1 illustrates a conventional automated exchange system 100 comprising trader terminals 110 that are used for issuing order data messages, i.e. input data received by the automated exchange 140. The trader terminals 110 are connectable, for example over the internet 120, or over some other connection means like a dedicated fiber 120B, to an electronic marketplace, i.e. an automated exchange 140. The automated exchange 140 can be hosted on a computer server or a cluster of computer servers. Sometimes the trader terminals 110 are connected to the automated exchange 140 through a gateway 130. The gateway 130 may be connected to, or being a part of, the automated exchange 140 and is configured to receive market actions, i.e. orders and/or quotes from the trader terminals 110. An entry gateway 130 is usually in connection with the automated exchange 104 on a dedicated network and forwards the market actions to the automated exchange 140 and further usually broadcast updates back to the trader terminals 110. It should however be understood that information being communicated to and from the automated exchange 140 and the trader terminals 101 could be communicated via a single communication path. While the trading terminals 110 in FIG. 1 are illustrated as trading terminals that traditionally are associated with manual input of market actions, the trading terminals 110 can also be implemented as algorithmic trading units, sometimes termed automatic order generators, having manual input means for control of the algorithmic trading unit. The algorithmic trading unit is pre-programmed with instructions to automatically generate sell and buy orders and quotes (or changes/cancellations thereof) in response to input data received from the automated exchange 140. The trading terminals 110 also represent market makers inputting quotes to the automated exchange 140.

Automated exchanges, such as the automated exchange 140, monitors incoming orders received by the automated exchange and attempts to identify, i.e. match, one or more previously received orders that are stored in an order book database, wherein each identified order is contra to the incoming order and has a favorable price relative to the incoming order. More specifically, if the incoming order is a bid then the identified order is an offer at a price that is identical to or less than the bid price. In a similar manner, if the incoming order is an offer at a particular price, the identified order is a bid at a price that is identical to or greater than the offer price.

Upon identification (matching) of a contra order, a minimum of the quantities associated with the identified order and the incoming order is matched and that quantity of each of the identified and incoming orders become two halves of a matched trade that is sent to a clearinghouse. The automated exchange then considers each identified order in this manner until either all of the identified orders have been considered or all of the quantity associated with the incoming order has been matched. If any quantity of the incoming order remains, an entry is created in the order book database and information regarding the incoming order is recorded therein.

If the automated exchange identifies multiple orders contra to the incoming order and that have an identical price, wherein the price of the multiple orders is favorable to the price of the incoming order, the automated exchange allocates the quantity of the incoming order among such identified orders in accordance with order prioritization, or allocation, algorithms.

One order allocation solution uses a FIFO (i.e. first-in/first-out) priority algorithm. A FIFO order allocation solution generally considers each identified order sequentially in accordance with when the identified order was received. The quantity of the incoming order is matched to the quantity of the identified order received earliest, then quantities of the next earliest, and so on until the quantity of the incoming order is exhausted. FIG. 2 illustrates how an incoming order to sell 100 lots of a financial instrument at a price of 66.50/lot received by the automated exchange 140 is allocated to standing, i.e. unmatched, orders. The table denoted 200 shows orders A-D that the automated exchange 140 has identified in the order book database that are contra to and that have a favorable price compared to the incoming order. Rows of the table 200 show information regarding unmatched buy orders A through D in the order book database. A column 201 shows the bid price of each order, a column 202 shows the time each order was received by the automated exchange, and a column 203 shows the quantity requested by each buy order. A column 204 shows the portion of the quantity of the incoming order allocated to each of the unmatched orders A-D. In particular, the 30 units requested in buy order A are allocated first because the buy order A has the most favorable price (69.00). The remaining 70 units of the incoming order are then allocated to the orders B-D in accordance with the time they were received (represented by the time stamp given at receipt by the automated exchange 140) because such orders are all at the same price (i.e. 68.00). Therefore, the orders B and C are allocated 40 and 30 units of the remaining 70 units of the incoming order, respectively. Because the quantity of the incoming order is thereafter exhausted, the remainder of the buy order C, and all of the buy orders D are not allocated any portion of the incoming order. As will be understood, the FIFO allocation solution generally rewards speed in the sense that orders received first are prioritized over orders that were received later.

Another order allocation solution uses the pro-rata allocation priority algorithm. According to this solution, the quantity of an incoming order is allocated to each of a plurality of standing orders proportionally in terms of volume. FIG. 3 illustrates an example of how the pro-rata allocation priority solution works. FIG. 3 is an example of how an incoming order to sell 100 lots of a financial instrument with a price of 66.50/lot is allocated among buy orders using the pro-rata order allocation. As with the example of FIG. 2, the automated exchange 140 has identified orders A-D as being contra (i.e., orders to buy) to the incoming order (which includes an order to sell) and having a favorable price. Further, 30 lots of the incoming order are allocated to the 30 lots requested in the buy order A first because this order has the highest bid price (i.e., is most favorable). Thereafter, the remaining 70 lots are allocated to the orders B-D proportionally because these orders are at the same price. In particular, the automated exchange 140 calculates the total number of lots requested by the orders B-D, i.e. 100 units, and calculates a proportion the quantity of each order comprises of the total. A column 301 shows the bid price of each order, a column 302 shows the time each order was received by the automated exchange 140, and a column 303 shows the quantity requested by each buy order. Column 304 shows the proportion corresponding to each order. The automated exchange calculates the portion of the remaining quantity (70) of the incoming order to allocate to each of the orders B-D by multiplying the proportion of the total requested by the order and the quantity remaining. Typically, the automated exchange 140 rounds the calculated quantity to an integer and whether the automated exchange rounds up, down, or to a nearest integer is determined by the automated exchange in question. Any quantity of the incoming order that remains after pro-rata allocation can be allocated to any orders that have an unfilled quantity on a FIFO basis. For example, for the order B, the automated exchange multiplies the proportion of quantity requested by the order B (i.e., 40%) by the remaining quantity (70) and thus allocates 28 lots of the remaining 70 lots to this buy order. Column 306 shows the quantity of the incoming order allocated to each of the orders A-D. As will be understood, the pro-rata order allocation rewards, or favors, buy orders with large volumes.

Order allocation solutions used by automated exchanges for a particular market may affect the liquidity of the market. Specifically, some order allocation solutions such as the FIFO allocation may encourage traders to submit more orders, where each order is relatively small. Other order allocation solutions may encourage traders to submit orders of larger volumes. There is a constant need and desire to improve upon existing automated exchanges and to provide solutions that operate with fewer drawbacks than pre-existing automated exchange systems. To this end and as markets and technologies develop the order allocation solutions used by automated exchanges must also develop accordingly to enhance liquidity, etcetera, in the market.

### SUMMARY

It is with respect to above considerations and others that the various embodiments of the present invention have been made. It is therefore a general object of embodiments of the present invention to improve upon existing automated exchanges and to provide improved solutions that operate with fewer drawbacks than pre-existing automated exchanges and/or solutions.

While the above-mentioned order allocation solutions are efficient in many aspects, the present inventor has realized that there is room for continuous improvements. For example, the inventor has realized that there is a need for an order allocation solution that is fairer to market makers that bring liquidity to the market. Or said differently, the inventor has identified a need for a technical solution that favors, or rewards, market makers that bring, or provide, liquidity to the market.

Thus and according to a first aspect, there is provided method of allocating a quantity of an order that is included in an incoming order data message. The method includes receiving, by a receiver circuitry, a signal comprising an incoming order data message that includes an order with an instruction to sell or buy a quantity of a specified financial instrument. Then accessing, by a processing circuitry, for each pending limit-order data message associated with said specified financial instrument, a portion of the respective limit-order data message to determine a trading participant identity parameter associated with the respective limit-order data message and determining, by the processing circuitry, for each trading participant identity parameter having pending limit-order data messages associated with said specified financial instrument, an aggregated time spent on a best-bid-offer value for said specified financial instrument. After which follows allocating, by the processing circuitry, at least a first portion of the quantity of the order to said pending limit-orders based on the aggregated time spent on the best-bid-offer value by said determined trading identity parameter.

In one example embodiment, the determining further includes determining the aggregated time spent on the best-bid-offer value for a pre-defined period of time. For example, the pre-defined period of time may comprise the last twenty-four hours. Additionally, or alternatively, the pre-defined period of time may comprise the previous trading day. Additionally, or alternatively, the pre-defined period of time may comprise the current trading day.

In accordance with one example embodiment, the step of allocating comprises determining, by the processing circuitry, to give preference to those pending limit-orders that are associated with trading participant identity parameters that have the longest aggregated time spent on the best-bid-offer value.

In one embodiment, each limit-order data message comprises a volume parameter indicating a volume of the limit-order included in the limit-order data message. The method may further comprises accessing, by the processing circuitry, for each pending limit-order data message associated with said specified financial instrument, a portion of the respective limit-order message to determine a volume parameter associated with the respective limit-order data message. Also, the step of allocating may comprise allocating the at least first portion of the quantity of the order to said pending limit-orders based on a combination of the aggregated time spent on the best-bid-offer value by said determined trading identity parameter and the determined volume parameters of the respective limit-order data messages. For example, the step of allocating may comprise determining, by the processing circuitry, to apply a weighting criterion to give weighted preference between aggregated time spent on the best-bid-offer value by said determined trading identity parameter and the determined volume parameters of the respective limit-order data messages.

In one embodiment, each limit-order data message comprises a volume parameter indicating a volume of the limit-order included in the limit-order data message. The method may also further comprise: accessing, by the processing circuitry, for each pending limit-order data message associated with said specified financial instrument, a portion of the respective limit-order message to determine a volume parameter associated with the respective limit-order data message; and allocating, by the processing circuitry, at least a second portion of the quantity of the order to said pending limit-orders based on the determined volume parameters. The step of allocating the at least the second portion of the quantity of the order to said pending limit-orders based on the determined volume parameters may further comprise determining, by the processing circuitry, to give preference to those pending limit-orders that have volume parameters indicating the highest, or biggest, volumes.

According to a second aspect, there is provided an automated exchange for allocating a quantity of an order that is included in an incoming order data message. The automated exchange comprises a receiver circuitry configured to receive a signal comprising an incoming order data message that includes an order with an instruction to sell or buy a quantity of a specified financial instrument. The automated exchange also comprises a processing circuitry configured to: access, for each pending limit-order data message associated with said specified financial instrument, a portion of the respective limit-order data message to determine a trading participant identity parameter associated with the respective limit-order data message; determine, for each trading participant identity parameter having pending limit-order data messages associated with said specified financial instrument, an aggregated time spent on a best-bid-offer value for said specified financial instrument; and allocate at least a first portion of the quantity of the order to said pending limit-orders based on the aggregated time spent on the best-bid-offer value by said determined trading identity parameter.

In some embodiments, the processing circuitry is implemented in an order matching module.

The processing circuitry may be configured to determine the aggregated time spent on the best-bid-offer value for a pre-defined period of time. The pre-defined period of time may comprise the last twenty-four hours. The pre-defined period of time may comprise the previous trading day. The pre-defined period of time may comprise the current trading day.

In one example embodiment, the processing circuitry is configured to give preference to those pending limit-orders that are associated with trading participant identity parameters that have the longest aggregated time spent on the best-bid-offer value.

In one embodiment, each limit-order data message comprises a volume parameter indicating a volume of the limit-order included in the limit-order data message. The processing circuitry may be configured to: access, for each pending limit-order data message associated with said specified financial instrument, a portion of the respective limit-order message to determine a volume parameter associated with the respective limit-order data message; and allocate the at least first portion of the quantity of the order to said pending limit-orders based on a combination of the aggregated time spent on the best-bid-offer value by said determined trading identity parameter and the determined volume parameters of the respective limit-order data messages. In one embodiment, the processing circuitry is configured to determine to apply a weighting criteria to give weighted preference between aggregated time spent on the best-bid-offer value by said determined trading identity parameter and the determined volume parameters of the respective limit-order data messages.

In one embodiment, each limit-order data message comprises a volume parameter indicating a volume of the limit-order included in the limit-order data message. The processing circuitry may be configured to: access, for each pending limit-order data message associated with said specified financial instrument, a portion of the respective limit-order message to determine a volume parameter associated with the respective limit-order data message; and allocate at least a second portion of the quantity of the order to said pending limit-orders based on the determined volume parameters. Furthermore, the processing circuitry may be configured to determine to give preference to those pending limit-orders that have volume parameters indicating the highest, or biggest, volumes.

Various embodiments of present invention provide a novel and improved order allocation solution. The various embodiments of the invention may allow for an order allocation, which favors (or, rewards) orders that belong to trading participants that bring liquidity to the market place.

### BRIEF DESCRIPTION OF DRAWINGS

Embodiments of present invention will now be described in more detail, by non-limiting examples and with reference to the accompanying drawings, in which:

FIG. 1 illustrates an automated exchange for automated electronic trading of financial instruments;

FIG. 2 illustrates an example of allocating an incoming sell order to standing, or unmatched, buy orders according to a FIFO allocation;

FIG. 3 illustrates an example of allocating an incoming sell order to standing, i.e. unmatched, buy orders using a pro-rata allocation;

FIG. 4 illustrates a block diagram of an embodiment of the present invention;

FIG. 5 illustrates an example order data message;

FIG. 6 illustrates an example of allocating an incoming sell order to standing, or unmatched, buy orders according to an embodiment of the present invention;

FIG. 7 illustrates an example of allocating an incoming sell order to standing, or unmatched, buy orders according to another embodiment of the present invention;

FIG. 8 illustrates an example of allocating an incoming sell order to standing, or unmatched, buy orders according to yet another embodiment of the present invention;

FIG. 9 illustrates a method according to an embodiment of the present invention;

FIG. 10 illustrates a method according to another embodiment of the present invention; and

FIG. 11 illustrates a method according to yet another embodiment of the present invention.

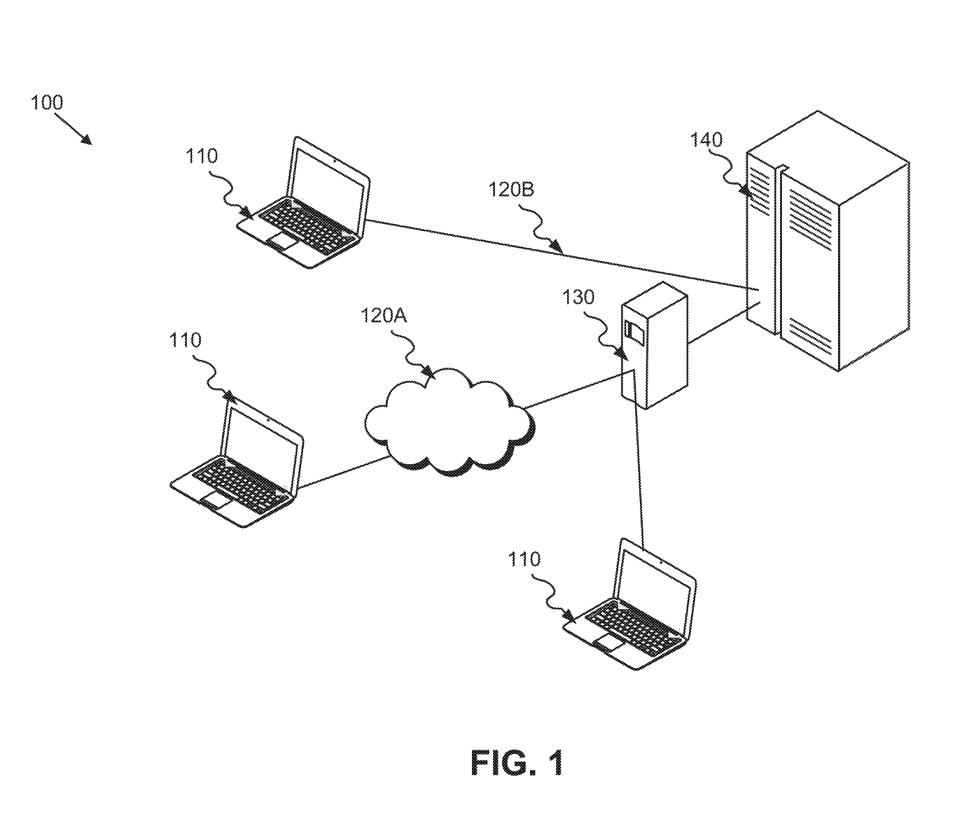

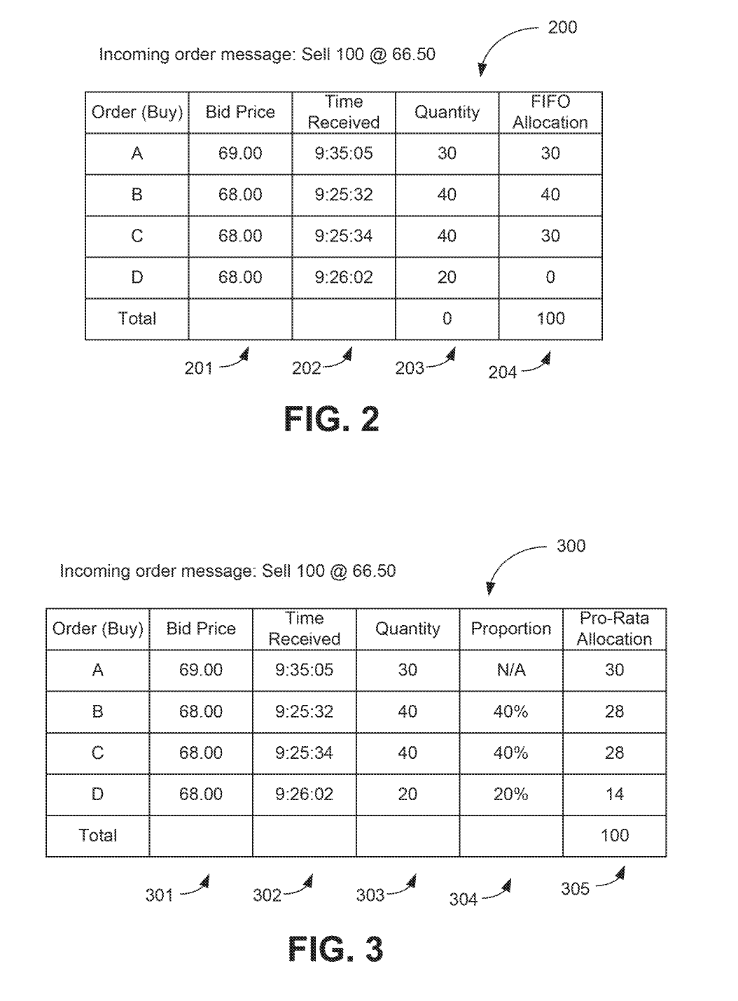

### DETAILED DESCRIPTION

The invention will now be described more fully hereinafter with reference to the accompanying drawings, in which certain embodiments of the invention are shown. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like numbers refer to like elements throughout the description.

In short, an aim with embodiments of the present invention is to provide an alternative order allocation solution when matching orders in an automated exchange. Also, it would be advantageous to provide an order allocation solution, which favors trading participants that bring liquidity to the market.

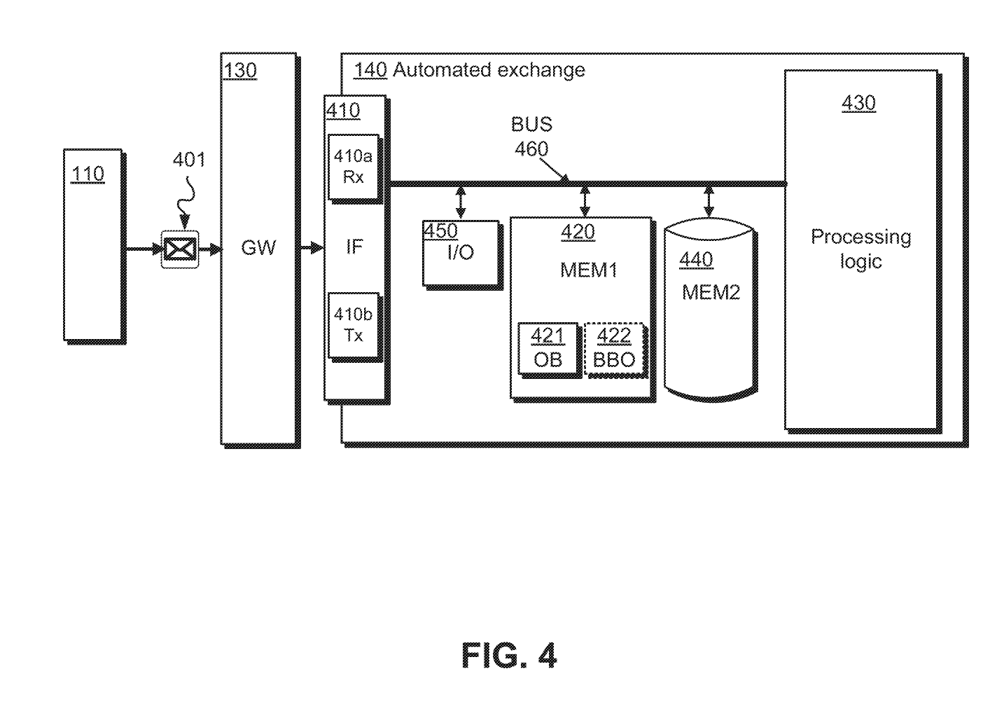

FIG. 4 illustrates an example embodiment of the automated exchange 140, implemented on a computer and comprising a memory 420 (typically a random access memory, RAM, or another non-volatile storage means), a processing circuitry (or, processing logic) 430, a storage memory 440 (e.g. a hard drive) and an input/output (I/O) controller 450, all coupled by a bus 460. The processing circuitry 430 may include a processor, microprocessor, an ASIC, FPGA, or the like.

The automated exchange 140 is configured to receive a signal comprising a message 401, typically but not necessarily via a gateway 130. The received message 401 which includes an order data message to buy or sell a financial instrument, further includes at least one order specific parameter for the financial instrument to be traded. The order specific parameter for the financial instrument to be traded is typically order size and/or order prize. In some embodiments of the invention there can also be other order characteristics, such as order type, that are order specific parameters for the financial instrument. Additionally, the order specific parameter may be a trading participant identity parameter. The message 401 is then routed, typically via a communication interface module 410 of the automated exchange, to the processing circuitry 430. The communication interface module 410 may comprise a receiver circuitry 410a for receiving signals, e.g. comprising data messages. Additionally, the communication interface module may comprise a transmitter circuitry 410b for transmitting signals, e.g. comprising data messages. In some embodiments, the receiver and transmitter circuitries may be embodied as one single transceiver circuitry for both transmitting and receiving signals.

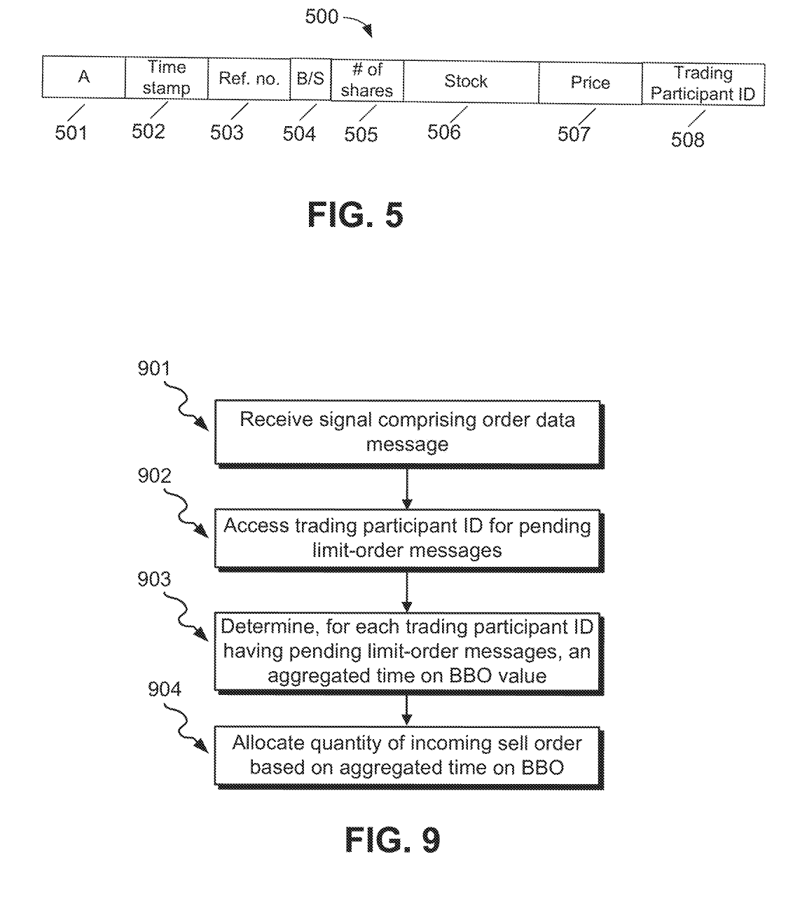

The memory 420 is configured to store validated, but unmatched (i.e. standing), limit-order data messages in an order book 421, or order book database. In the order book 421, one or several limit-order data messages can be stored. An example format of a stored limit-order data message 500 is shown in FIG. 5. A first information element 501 comprises update type, in this example “Add” which relates to a new order. A second information element 502 comprises a time stamp parameter indicating the time the order data message 500 was received by the automated exchange. A third element 503 comprises a reference indicator, or number. A fourth element 504 comprises an order type parameter indicating whether the limit-order message relates to an instruction to sell or buy. A fifth element 505 comprises a parameter indicating the order volume, or order size, of the financial instrument (e.g., number of shares). The order volume indicates the quantity of the specified financial instrument the trading participant wants to buy/sell. A sixth element 506 comprises a parameter indicating the type of financial instrument (e.g. stock). A seventh element comprises a parameter indicating the order price, i.e. the price the trading participant has given to the buy/sell order. Finally, a seventh element 507 comprises a trading participant identity parameter, which represents an identification of the trading participant having placed the order.

With reference to FIGS. 4-8, example embodiments of the present invention will be now detailed.

A receiver circuitry 410a is configured to receive a signal comprising an incoming order data message 401 that includes an order with an instruction to sell or buy a quantity of a specified financial instrument, e.g. a stock.

The processing circuitry 430, or processing logic, is configured to access, for each pending limit-order data message that are stored in an order book 421 associated with the specified financial instrument, a portion of the respective limit-order data message to determine a trading participant identity parameter associated with the respective limit-order data message. That is, the processing circuitry 430 may for example access the trading participant identity parameters from information elements 508 included in stored limit-order data messages.

The processing circuitry 430 is furthermore configured to determine, for each trading participant identity parameter having pending limit-order data messages associated with the specified financial instrument, an aggregated time spent on a best-bid-offer (BBO) value for the specified financial instrument. As used herein, the BBO value is generally used to mean the highest quoted bid for a specified financial instrument among all those offered by the pending limit-orders. The best bid is effectively the highest price that a trading participant is willing to pay for a lot of a specified financial instrument. A bid is an offer made by a trading participant to purchase a specified financial instrument. The bid specifies both the price that the buyer is willing to pay and the quantity of the financial instrument that is desired.

The above-mentioned determination made by the processing circuitry 430 can be implemented, or realized, in numerous ways. In one example embodiment, the memory 420 is configured to store best-bid-offer (BBO) values 422. For example, memory 420 may be configured to store historical data relating to the BBO values 422. The historical data relating to the BBO values may include (in addition to the BBO values themselves) a respective time stamp, or other similar information element, indicating the time period the respective BBO values were BBO values. That is, the time stamp is configured to indicate the start time and the end time, respectively, for the time period when the respective BBO values were BBO values. Since all pending limit-orders in the order book 421 include time stamps with information about the point in time they were received by the automated exchange 140, it is possible to compare these time stamps against the start and end times of the respective BBO values. In other words, the processing circuitry 430, or processing logic, can be configured to compare time stamps of pending limit-orders in the order book 421 against historical data about the BBO values 422 and, thus, determine (for each trading participant identity parameter having pending limit-order data messages associated with said specified financial instrument) an aggregated time spent on a best-bid-offer (BBO) value for the specified financial instrument. Determining an aggregated time spent on a best-bid-offer (BBO) value for the specified financial instrument is in itself known in the art and so this will therefore not be further explained here.

It should be understood that determining the aggregated time spent on the BBO values may be pre-set to be done over a defined period of time. In one embodiment, this period of time comprises the last twenty-four hours. The specified period of time may preferably comprise the current trading day, because this would favor current trends of the trading. However, other time periods may be used as well, such as the previous trading day. It may be especially important to consider the previous trading day, or parts of the previous trading day, at early trading hours of a new trading day (e.g. between 9.00 hours and 11.00 hours) because otherwise the order allocation may become less fair to some trading participants. The exact choice of time period may vary in dependence of the intended purpose and so the exact choice of this time period should be tested and evaluated in each specific case, i.e. for each specified financial instrument to be traded. The defined period of time can thus be set independently by providers of automated exchanges in dependence of desires, needs and/or characteristics of trading products to be offered to the market.

Also, a certain length of the time period may be desired, such as a trading day, 24 hours, 72 hours, a trading week, etcetera. However, the exact choice of the length of this time period may vary in dependence of the intended purpose and so the exact choice of the length of the time period should be tested and evaluated in each specific case, i.e. for each specified financial instrument to be traded. Again, the exact length of this pre-defined period of time can be decided and set independently by providers of automated exchanges in dependence of their own desires, needs and/or characteristics of trading products to be offered to the market.

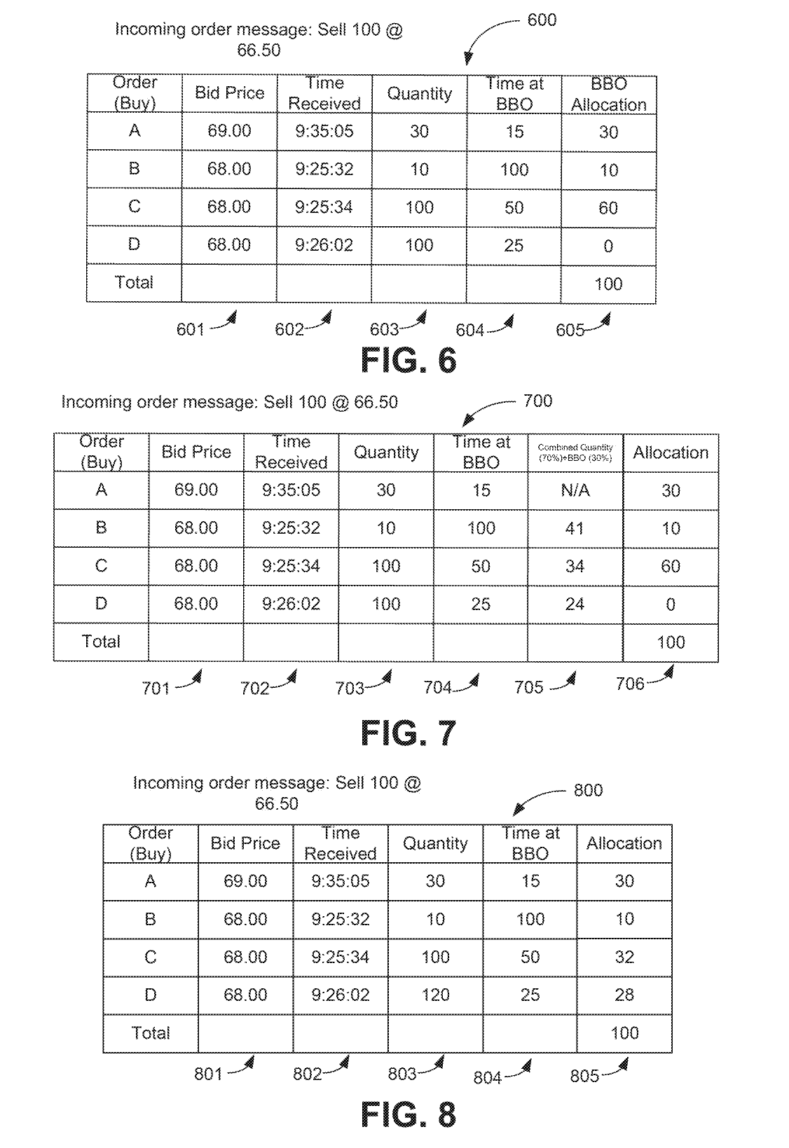

Yet further, the processing circuitry 430 is configured to allocate the quantity of the incoming order to the pending limit-orders based on the aggregated time spent on the BBO value by the determined trading identity parameters. In one example embodiment shown in FIG. 6, the processing circuitry 430 is configured to give preference to those pending limit orders that are associated with trading participant identity parameters that have the longest aggregated time spent on the BBO values.

FIG. 6 illustrates how an incoming order to sell 100 lots of a financial instrument (e.g. a certain stock) at a price of 66.50/lot received by the automated exchange 140 is allocated to standing, i.e. unmatched, orders that are stored in order book 421. The table denoted 600 shows orders A-D that the automated exchange 140 has identified in the order book database 421 that are contra to and that have a favorable price compared to the incoming order. Rows of the table 600 show information regarding unmatched buy orders A through D in the order book database 421. A column 601 shows the bid price of each order, a column 602 shows the time each order was received by the automated exchange, and a column 603 shows the quantity requested by each buy order. A column 604 shows the determined aggregated time spent on a BBO value by the trading participants having put the buy orders A, B, C and D, respectively. In this example, the time at BBO is according to an exemplary, but unspecified, time unit. The time unit may e.g. be in seconds, minutes, hours, etcetera. In this example, the 30 units requested by the buy order A are allocated first because the buy order A has the most favorable price (69.00). The remaining 70 units of the incoming order are then allocated to the orders B-D in dependence of historical data representing the total time the trading participants (that have put buy orders B, C, D, respectively) have spent on BBO values over a pre-defined period of time. In this example, the trading participant of buy order B has spent 100 time units at BBO, whereas the trading participants of buy orders C and D have spent 50 time units and 25 time units at BBO, respectively. Since the trading participant that put buy order B has spent most time at BBO, the 10 units requested by buy order B will be allocated to buy order B. Then, the remaining quantity of the sell order will be allocated to the buy order having the next-longest time at BBO, and so forth until the incoming sell order is exhausted. Therefore, the order C is allocated 60 units of the remaining 60 units of the incoming order. Because the quantity of the incoming order is thereafter exhausted, the remainder of the buy order C, and all of the buy order D are not allocated any portion of the incoming order. As will be understood, the this order allocation generally rewards buy orders belonging to trading participants that have spent most time at BBO (i.e. have brought liquidity to the market) over a past, pre-defined period of time.

Thus, an automated exchange 140 is provided that favors, or rewards, those trading participants that spend most time on BBO values. The amount of time spent on BBO values by a certain trading participant is an indication of how often this certain trading participant offers the best bid or best offer in the market. A trading participant that offers best bids or best offers often generally contributes to the improvement of the specified financial instrument's ability to be sold. Or said differently, a trading participant that offers best bids or best offers provide liquidity to the pending limit-orders of the order book in the sense that it improves the ability for the underlying specified financial instrument to be sold. In other words, since the automated exchange 140 favors, or rewards, those trading participants that spend most time on BBO values, the automated exchange 140 can be said to provide an order allocation solution, which favors trading participants that bring liquidity to the market.

In a similar, yet alternative, embodiment with reference to FIGS. 4, 5 and 7, the processing circuitry 430 is configured to allocate the quantity of the incoming order to the pending limit-orders based on a combination of the aggregated time spent on the BBO value by the determined trading identity parameters and determined volume parameters of the respective pending limit-order data messages. In such embodiment, the processing circuitry 430 may configured to consider aggregated time spent on the BBO values and, at the same time, consider the volume parameters (cf. e.g. information element 505 in FIG. 5).

In one embodiment, the processing circuitry 430 is configured to apply weighting criteria to give weighted preference between aggregated time spent on the BBO value by said determined trading identity parameter and the determined volume parameters of the respective limit-order data messages. As will be further detailed with reference to FIG. 7, the processing circuitry may give 70 percent value, or weight, to “volume” and 30 percent value to “aggregated time on the BBO” according to one example embodiment. In other words, the order allocation of the quantity of the incoming sell order can be allocated to the pending limit-orders in dependence of the volume parameters of the pending limit-orders as well as the aggregated time spent on the BBO values by those trading participant identities having pending limit-orders in the order book 421.

FIG. 7 illustrates how an incoming order to sell 100 lots of a financial instrument (e.g. a certain stock) at a price of 66.50/lot received by the automated exchange 140 is allocated to standing, i.e. unmatched, orders that are stored in order book 421. The table denoted 700 shows orders A-D that the automated exchange 140 has identified in the order book database 421 that are contra to and that have a favorable price compared to the incoming order. Rows of the table 700 show information regarding unmatched buy orders A through D in the order book database 421. A column 701 shows the bid price of each order, a column 702 shows the time each order was received by the automated exchange, and a column 703 shows the quantity requested by each buy order. A column 704 shows the determined aggregated time spent on a BBO value by the trading participants having put the buy orders A, B, C and D, respectively. In this example, the time at BBO is according to an exemplary, but unspecified, time unit. The time unit may e.g. be in seconds, minutes, hours, etcetera. In this example, the 30 units requested by the buy order A are allocated first because the buy order A has the most favorable price (69.00). The remaining 70 units of the incoming order are then allocated to the orders B-D in dependence of a combination of determined volume parameters and the time spent on BBO by the trading participants of the buy orders B, C and D, respectively. In this example, the automated exchange applies a weighting criteria giving the order volume/order size 30% value (or, weight) and giving the total time at BBO by the respective trading participants 70% value. If applying this weighting criteria, the buy order B having the relatively smaller order size will become prioritized over buy orders C and D, respectively, because the trading participant that put buy order B has spent considerably more time at BBO over a past, pre-defined period of time. Accordingly, the requested quantity of 10 units of the remaining 70 units will be allocated to the buy order B. Buy orders C and D have equal order sizes (i.e. 100 units) and order C will be prioritized over order D, because the trading participant of order C has spent comparatively more time at BBO (50 time units vs. 25 time units). Consequently, the order C is allocated 60 units of the remaining 60 units. Because the quantity of the incoming order is thereafter exhausted, the remainder of the buy order C, and all of the buy order D are not allocated any portion of the incoming order. As will be understood, the this allocation scheme generally rewards buy orders belonging to trading participants that have spent most time at BBO (i.e. have brought liquidity to the market) over a past, pre-defined period of time.

When applying a 70-30 weighting criteria as above, the automated exchange 140 may allow for an order allocation solution, which favors trading participants that bring liquidity to the order book. At the same time, in order not to favor, or reward, trading participants with too small order sizes that are anyhow frequently at the BBO, this weighting criteria also considers order size/order volume and give somewhat preference to those trading participants that put buy orders with a certain order size/order volume. Weighting rules other than the 70-30 weighting rule above are of course possible in dependence of which limit-orders a provider of the automated exchange 140 would like to favor, or reward, when trading a specified financial instrument. The exact choice for the weighting rule may vary in dependence of the intended purpose or use of the automated exchange 140, e.g. the characteristics of the underlying financial instrument that is to be traded. Accordingly, the exact choice of how to weight between aggregated time spent on BBO and volume, respectively, should be tested and evaluated in each specific case. As will be understood, the exact weighting criteria can be decided and set independently by the provider of the automated exchange 140 in dependence of its own wishes and the specification of the financial instrument to be traded.

In yet an embodiment with reference to FIGS. 4, 5 and 8, the processing circuitry 430 is configured to allocate the quantity of the incoming order to the pending limit-orders based on a combination of the aggregated time spent on the BBO value by the determined trading identity parameters and determined volume parameters of the respective pending limit-order data messages. In such embodiment, the processing circuitry 430 may configured to consider aggregated time spent on the BBO values and, at the same time, consider the volume parameters (cf. e.g. information element 505 in FIG. 5) and allocate a first portion of the total, or remaining, quantity of the incoming order in dependence of the aggregated time spent on a BBO value by the trading participants and allocate a second portion of the total, or remaining, quantity of the incoming order in dependence of order size/order volume of the pending limit-order data messages. This embodiment allows for an order allocation solution which can be viewed as a combination of the aggregated time spent on BBO values and a pro-rata model based on volume.

FIG. 8 illustrates how an incoming order to sell 100 lots of a financial instrument (e.g. a certain stock) at a price of 66.50/lot received by the automated exchange 140 is allocated to standing, i.e. unmatched, orders that are stored in order book 421. The table denoted 800 shows orders A-D that the automated exchange 140 has identified in the order book database 421 that are contra to and that have a favorable price compared to the incoming order. Rows of the table 800 show information regarding unmatched buy orders A through D in the order book database 421. A column 801 shows the bid price of each order, a column 802 shows the time each order was received by the automated exchange, and a column 803 shows the quantity requested by each buy order. A column 804 shows the determined aggregated time spent on a BBO value by the trading participants having put the buy orders A, B, C and D, respectively. In this example, the time at BBO is according to an exemplary, but unspecified, time unit. The time unit may e.g. be in seconds, minutes, hours and etcetera. In this example, the 30 units requested by the buy order A are allocated first because the buy order A has the most favorable price (69.00). In this example, a first portion (60%) of the remaining quantity (i.e. 42 units) of the incoming sell order can be allocated to pending limit-orders based on the aggregated time spent on the BBO whereas another, different, portion (40%) of the remaining quantity (i.e. 28 units) can be allocated in dependence of the volume parameters. The remaining 70 units of the incoming order are thus allocated to the orders B-D in dependence of a combination of determined volume parameters and the time spent on BBO by the trading participants of the buy orders B, C and D, respectively. In this example, 60% or 42 units of the remaining quantity is allocated based on the time spent at BBO of the trading participants having put orders B, C and D, respectively. Since the trading participant of buy order B has spent a comparatively longer time at BBO, the requested quantity of 10 units will be allocated to buy order B first. After the 10 units have been allocated to buy order B, there remain 32 units to be allocated to the remaining buy orders C and D based on the time spent at BBO. The trading participant having put order C has spent more time at BBO compared to the trading participant of order D (50 time units vs. 25 time units). Therefore, the remaining 32 units will be allocated to order C. Next, 28 units of the incoming sell order shall be allocated to the pending limit-order messages based on the order size/order volume. The order D has a bigger order size than order C (120 units vs. 100 units) and, consequently, the 28 units will be allocated to order D. Because the quantity of the incoming order is thereafter exhausted, the remainder of the buy orders C (68 units) and D (92 units) are not allocated any portion of the incoming order.

When applying a 60-40 criteria as above, the automated exchange 140 may allow for an order allocation solution, which gives preference those pending limit orders that are associated with trading participant identity parameters that have the longest aggregated time spent on BBO values for 60% of a certain quantity of the incoming (sell) order whereas, for the remaining 40% of the same quantity, preference is given to pending limit-orders having the best volume parameters (i.e. volume parameters indicating high volumes). Percentages other than the 60-40 of the quantity above are of course conceivable in dependence of which limit-orders a provider of the automated exchange 140 would like to favor, or reward, when trading a specified financial instrument. In other words, the exact choice may vary in dependence of the intended purpose or use of the automated exchange 140, e.g. the characteristics of the underlying financial instrument that is to be traded. Accordingly, the exact choice of how to weight between aggregated time spent on BBO and volume, respectively, should be tested and evaluated in each specific case. As will be understood, the exact weighting criteria can be decided and set independently by the provider of the automated exchange 140 in dependence of its own wishes and the specification of the financial instrument to be traded.

FIG. 9 illustrates a flowchart illustrating example method steps of an embodiment of the present invention. The example method steps may be implemented, thus performed, by an automated exchange. A signal comprising an incoming order data message that includes an order with an instruction to sell or buy a quantity of a specified financial instrument is received 901. For each pending limit-order data message associated with the specified financial instrument, a portion of the respective limit-order data message is accessed 902 to determine a trading participant identity parameter associated with the respective limit-order data message. For example, the information element 508 (see FIG. 5) can be accessed from each of the pending limit-order data messages that are stored in a order book database. For each trading participant identity parameter having pending limit-order data messages (e.g. stored in the order book database) associated with the specified financial instrument, an aggregated time spent on a best-bid-offer (BBO) value for said specified financial instrument is determined 903. The aggregated time spent on the BBO value may be determined for a pre-defined period of time. The pre-defined period of time may comprise twenty-four hours, e.g. the last twenty-four hours. The pre-defined period of time may, e.g., comprise the current trading day and/or the previous trading day.

Also, a portion of the quantity of the incoming order is allocated 904 to said pending limit-orders based on the aggregated time spent on the best-bid-offer value by said determined trading identity parameter. The allocation 904 may, e.g., comprise determining to give preference to those pending limit-order data messages that are associated with trading participant identity parameters that have the longest aggregated time spent on the BBO value.

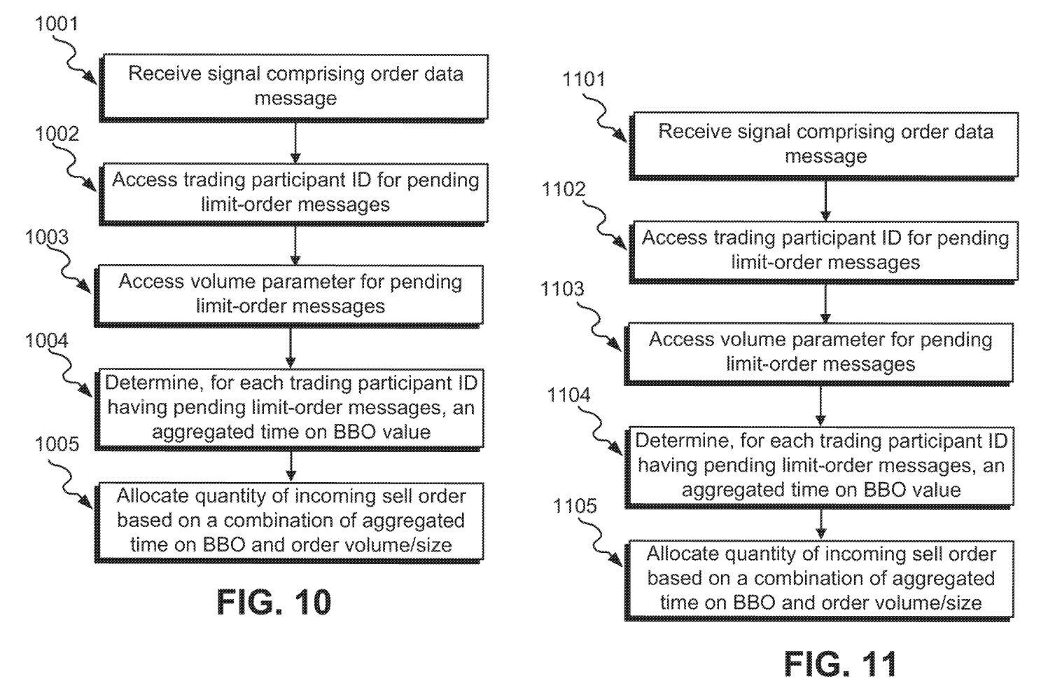

FIG. 10 illustrates a flowchart illustrating example method steps of another embodiment of the present invention. The example method steps may be implemented, thus performed, by an automated exchange. A signal comprising an incoming order data message that includes an order with an instruction to sell or buy a quantity of a specified financial instrument is received 1001. For each pending limit-order data message associated with the specified financial instrument, a portion of the respective limit-order data message is accessed 1002 to determine a trading participant identity parameter associated with the respective limit-order data message. For example, the information element 508 (see FIG. 5) can be accessed from each of the pending limit-order data messages that are stored in a order book database. Also, for each pending limit-order data message associated with the specified financial instrument, a portion of the respective limit-order data message is accessed 1003 to determine the volume parameters of the respective limit-order data messages. For example, the information element denoted 505 (see FIG. 5) may be accessed 1003. For each trading participant identity parameter having pending limit-order data messages (e.g. stored in the order book database) associated with the specified financial instrument, an aggregated time spent on a best-bid-offer (BBO) value for said specified financial instrument is determined 1004. The aggregated time spent on the BBO value may be determined for a pre-defined period of time. The pre-defined period of time may comprise twenty-four hours, e.g. the last twenty-four hours. The pre-defined period of time may, e.g., comprise the current trading day and/or the previous trading day. Furthermore, a portion of the quantity of the incoming order is allocated 1005 to said pending limit-orders based on a combination of the aggregated time spent on the best-bid-offer value by said determined trading identity parameter and the determined volume parameters of the respective limit-order data messages. The allocation 1005 may comprise applying a weighting criterion to give weighted preference between aggregated time spent on the best-bid-offer (BBO) value by the determined trading identity parameters and the determined volume parameters of the respective limit-order data messages. In one example, the aggregated time spent on the BBO is given 70% weight, or importance, and the order volume is given 30% weight.

FIG. 11 illustrates a flowchart illustrating example method steps of yet another embodiment of the present invention. The example method steps may be implemented, thus performed, by an automated exchange. A signal comprising an incoming order data message that includes an order with an instruction to sell or buy a quantity of a specified financial instrument is received 1101. For each pending limit-order data message associated with the specified financial instrument, a portion of the respective limit-order data message is accessed 1102 to determine a trading participant identity parameter associated with the respective limit-order data message. Also, for each pending limit-order data message associated with the specified financial instrument, a portion of the respective limit-order data message is accessed 1103 to determine the volume parameters of the respective limit-order data messages. For each trading participant identity parameter having pending limit-order data messages (e.g. stored in the order book database) associated with the specified financial instrument, an aggregated time spent on a best-bid-offer (BBO) value for said specified financial instrument is determined 1104. The aggregated time spent on the BBO value may be determined for a pre-defined period of time. The pre-defined period of time may comprise twenty-four hours, e.g. the last twenty-four hours. The pre-defined period of time may, e.g., comprise the current trading day and/or the previous trading day. A first portion (e.g. 60%) of the quantity of the incoming order is allocated 1105 to the pending limit-orders based on the aggregated time spent on the best-bid-offer value by the determined trading identity parameter. Also, a second portion (e.g. the remaining 40%) of the quantity of the incoming order is allocated 1105 to the pending limit-orders based on the determined volume parameters.

The methods described with reference to FIGS. 9, 10 and 11, respectively, can be implemented by hardware, software or a combination of both hardware and software.

Various embodiments of the present invention described throughout this disclosure allow for a novel order allocation solution when matching orders in an automated exchange. Various embodiments of the present invention are advantageous, because they to provide order allocation solutions, which reward trading participants that bring liquidity to the market. Accordingly, in an automated exchange an incoming sell order can e.g. be allocated to standing buy orders based on the aggregated time the trading participant having standing buy orders have spent on a best-bid-offer (BBO) value over a past, pre-defined, period of time. Hereby, it is made possible to improve trading of financial instruments when it is desired to favor, or reward, order allocation to trading participants that bring liquidity to the market of the financial instrument in question.

Although the present invention has been described above with reference to specific embodiments, it is not intended to be limited to the specific form set forth herein. Rather, the invention is limited only by the accompanying claims and, other embodiments than the specific above are equally possible within the scope of the appended claims. All changes which come within the meaning and range of equivalency of the claims are to be embraced within their scope. Also, when used herein the terms “comprise/comprises” and “include/includes” does not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1. A method performed on a computer server system that includes a memory device storing a plurality of pending data messages that are to be operated on, each one of the plurality of pending data messages having (a) a numerical value for a numerical parameter, (b) a data message type identifier for the respective data message, and (c) a participant identity value that is for a participant identity parameter of the respective pending data message, the computer server system including processing circuitry and receiver circuitry, the method comprising:
receiving, by the receiver circuitry, a signal comprising an incoming data message that includes a data transaction request with (a) a specified data message type identifier, (b) at least one predefined instruction from among a plurality of possible predefined instructions, and (c) a quantity value;
in response to reception of the incoming data message and for each one of the plurality of pending data messages, selecting those ones of the plurality of pending data messages that have a data message type identifier that is the same as the specified data message type identifier contained in the data transaction message of the incoming data message;
generating a list of participant identity values from those selected ones of the plurality of pending data messages, wherein each member of the generated list is a different participant identity value and each participant identity value from those selected ones of the plurality of pending data messages is included in the generated list;
for each participant identity value in the generated list of participant identity values:
determining, from the pending data messages, a set of pending data messages that have the corresponding participant identity value;
calculating, from the set of pending data messages, an aggregate time that the set of pending data messages have spent on at least one dynamically determined numerical value; and
processing, by the processing circuitry, the data transaction request included in the incoming data message against the plurality of pending data messages based on the calculated aggregate time.

2. The method according to claim 1, wherein data transaction request included in the incoming data message against the plurality of pending data messages further comprises:
processing, by the processing circuitry, the data transaction request included in the incoming data message by preferentially treating those pending data messages that are associated with participant identity parameters that have been determined to have a longer time spent on the at least one dynamically determined numerical value

3. The method according to claim 1, wherein calculation of an aggregate time further comprises:
calculating the time spent on the at least one dynamically determined numerical value over a pre-defined period of time.

4. The method according to claim 3, wherein the pre-defined period of time comprises the last twenty-four hours.

5. The method according to claim 3, wherein the pre-defined period of time comprises a prior day or a portion thereof.

6. The method according to claim 3, wherein the pre-defined period of time comprises the current day or a portion thereof.

7. The method according to claim 1, wherein the numerical parameter is a volume parameter indicating a volume of the incoming data transaction request, where each numerical value is a volume value for the corresponding pending data message, and wherein the method further comprises:
for each one of the plurality of pending data messages having the specified data message type identifier, accessing, by the processing circuitry, the respective pending data message to determine the volume value of the volume parameter; and
the processing further comprises processing the data transaction request based on a combination of the calculated aggregate time and the determined volume value.

8. The method according to claim 7, wherein the calculated aggregate time is combined with the determined volume value based on a weighting criteria that gives preference between (1) the time spent on the at least one dynamically determined numerical value by the specified determined participant identity parameter and (2) the determined volume value of the respective data messages.

9. The method according to claim 2, wherein the numerical value is a volume value, the method further comprising:
for each one of the plurality of pending data message associated with the specific data message type identifier, accessing, by the processing circuitry, the respective pending message to determine the volume; and
wherein the processing further comprises allocating, by the processing circuitry, a first amount of the quantity value of the order to said pending data messages based on the determined volume value.

10. The method according to claim 9, wherein the first amount is allocated to give preference to those pending data messages that have volume values indicating the highest volumes.

11. A computer server system for allocating a quantity of a data transaction request that is included in an incoming data message, the computer server system comprising:
a memory device configured to store a plurality of pending data messages that are each associated with a corresponding (a) data message type identifier, (b) participant identity value, and (c) numerical value;
a receiver circuitry configured to receive a signal comprising the incoming data message that includes a data transaction request with (a) a specified data message type identifier, (b) at least one predefined instruction from among a plurality of possible predefined instructions, and (c) a quantity value; and
a processing circuitry coupled to the receiver circuitry, the processing circuitry configured to:
select those ones of the plurality of pending data messages that have a data message type identifier that is the same as the specified data message type identifier contained in the data transaction message of the incoming data message;
generate a list of participant identity values from the those selected ones of the plurality of pending data messages, wherein each member of the generated list is a different participant identity value and each participant identity value from those selected ones of the plurality of pending data messages is included in the list;
for each corresponding participant identity value in the list of participant identity values:
(a) determine, from the pending data messages, a set of pending data messages that have the corresponding participant identity value;
(b) calculate, from the set of pending data messages, an aggregate time that the set of pending data messages has spent on at least one dynamically determined numerical value; and
process the data transaction request that is included in the incoming data message by allocating portions of the quantity value to said pending data messages based on the calculated aggregate time spent on the dynamically determined numerical value by said determined participant identity parameter.

12. The computer server system according to claim 11, wherein the select, generate, determine, calculate, and processing are implemented in a matching module.

13. The a computer server system according to claim 11, wherein the processing circuitry is further configured to give preference to those pending data messages that are associated with participant identity values that have the longest time spent on the dynamically determined numerical value.

14. The computer server system according to claim 11, wherein the aggregate calculation is an aggregate over a pre-defined period of time.

15. The computer server system according to claim 14, wherein the pre-defined period of time comprises the last twenty-four hours.

16. The computer server system according to claim 14, wherein the pre-defined period of time comprises the previous day.

17. The computer server system according to claim 14, wherein the pre-defined period of time comprises the current day.

18. The computer server system according to claim 11, wherein the numerical value of each one of the pending data messages is a volume value that indicates how much can be allocated to the pending data message, and wherein the processing circuitry is further configured to:
access, for each one of the plurality of pending data messages associated with said specified data message type identifier, the respective pending data message to determine the volume value associated with the respective pending data message; and
allocate the data transaction request to said pending data messages based on a combination of the aggregate time spent on the dynamically determined numerical value by said determined participant identity parameter and the determined volume values of the respective pending data messages.

19. A non-transitory computer readable storage medium tangibly storing computer executable instructions for use by a computer system that includes at least one hardware processor, the computer system including a memory device configured to store a plurality of pending data messages that are each associated with a corresponding (a) data message type identifier, (b) participant identity value, and (c) numerical value, the computer system including a receiver configured to receive a signal comprising the incoming data message that includes a data transaction request with (1) a specified data message type identifier, (2) at least one predefined instruction from among a plurality of possible predefined instructions, and (3) a quantity value, the stored instructions comprising instructions configured to cause the at least one hardware processor to:
select those ones of the plurality of pending data messages that have a data message type identifier that is the same as the specified data message type identifier contained in the data transaction message of the incoming data message;
generate a list of participant identity values from the those selected ones of the plurality of pending data messages, wherein each member of the generated list is a different participant identity value and each participant identity value from those selected ones of the plurality of pending data messages is included in the list;
for each corresponding participant identity value in the list of participant identity values:
(a) determine, from the pending data messages, a set of pending data messages that have the corresponding participant identity value;
(b) calculate, from the set of pending data messages, an aggregate time that the set of pending data messages has spent on at least one dynamically determined numerical value; and
process the data transaction request that is included in the incoming data message by allocating portions of the quantity value to said pending data messages based on the calculated aggregate time spent on the dynamically determined numerical value by said determined participant identity parameter.

20. The non-transitory computer readable storage medium of claim 19, wherein the processing circuitry is further configured to give preference to those pending data messages that are associated with participant identity values that have the longest time spent on the dynamically determined numerical value are given a higher priority for allocation during the processing of the data transaction request.
